(19) United States
(12) Patent Application Publication
(10) Pub. No.: US 2021/0309465 A1
(43) Pub. Date: Oct. 7, 2021

(54) WORKPIECE HANDLING APPARATUS AND METHOD FOR BATCH PROCESSING PANEL-TYPE WORKPIECES

(71) Applicant: HOMAG Bohrsysteme GmbH, Herzebrock-Clarholz (DE)

(72) Inventor: Daniel SCHRAMM, Rheda-Wiedenbrück (DE)

(21) Appl. No.: 17/266,981

(22) PCT Filed: Aug. 5, 2019
(86) PCT No.: PCT/EP2019/070991

§ 371 Date: Feb. 8, 2021

(30) Foreign Application Priority Data
Aug. 8, 2018 (DE) 10 2018 119 280.0

(51) Int. Cl. B65G 47/90

(52) U.S. Cl. CPC B65G 47/90

(57) ABSTRACT

Workpiece handling apparatus for handling at least one panel-type workpiece which preferably consists at least in part of wood, wood-containing material, composite material or plastics material, comprising a lifting unit and a gripping unit, wherein the gripping unit is adapted to perform a displacement movement parallel to at least a first direction, and the gripping unit has a workpiece pick-up device which is so configured that it is able to enter into a reversible, force-based and/or form-fitting connection with at least one panel-type workpiece, characterised in that the gripping unit is so configured that the workpiece pick-up device can perform a displacement movement parallel to a second direction which is different from the first direction, and the lifting unit has at least one guide element which is configured to perform a displacement movement parallel to the second direction, and which is additionally configured to limit at least one degree of freedom of movement of the at least one panel-type workpiece.

### TECHNICAL FIELD

The invention relates to processing machines, in particular CNC machines, which process preferably panel-type workpieces of wood, wood-containing material, composite material, plastics material or the like. More specifically, the invention relates to the handling, more specifically the delivery of the workpieces in question into the processing region of a processing machine and/or the discharge of the workpieces in question from the processing region of a processing machine.

### PRIOR ART

Processing machines can be so configured that they are capable of picking up panel-type workpieces from a storage apparatus, transferring them to a processing region and carrying out one or more processing operations in that region. Processing machines configured in this way are preferably used when multiple panel-type workpieces are to be subjected sequentially to the same or similar processing steps.

EP1645379A1 discloses, for example, a processing machine having a gripping device which is configured to pick up panel-type workpieces from a panel-stacking region and to transfer them to the processing region of the processing machine. A panel-stacking region or a storage apparatus can be so configured that the height of the uppermost panel-type workpiece can be changed. This is the case, for example, when a panel stack is arranged on a scissor lift table (cf. DE102010001724A1).

A method for handling panel-type workpieces can comprise inter alia the following steps:
displacing a gripping device to the panel-stacking region;
picking up a panel-type workpiece;
transferring the panel-type workpiece which has been picked up to a processing region;
processing the panel-type workpiece;
removing the panel-type workpiece from the processing region in an unspecified manner;
lifting the panel stack by moving the scissor lift table vertically.

In particular as a result of the lifting of the panel stack, a situation comparable with the starting situation is present after the method has been carried out.

In principle, the largest possible number of panel-type workpieces which can be stored in the panel-stacking region is limited by the working height of the processing region, the panel thickness and the minimum height of the scissor lift table.

In order to increase the number of panel-type workpieces which can be stored, the processing machine, including the processing region, can be lifted, for example, by a platform. It is equally conceivable to lower the panel-stacking region relative to the processing machine, for example using a pit. In addition, special solutions relating to the scissor lift table are known, in which the scissor kinematics is arranged not beneath the vertically adjustable platform but laterally on both sides (double scissor lift table). With a suitable configuration, the vertically adjustable platform can then assume lower positions.

A disadvantage of the prior art is the fact that the efficiency of a processing machine can be limited by the handling of panel-type workpieces.

### DESCRIPTION OF THE INVENTION

The object of the invention is to provide, in the field of the mentioned processing machines, a simple, efficient and inexpensive possibility for handling panel-type workpieces.

This object is achieved according to the invention by a workpiece handling apparatus according to claim 1, a system according to claim 7, a processing machine according to claim 9 and a method according to claim 13. Preferred embodiments are given in the dependent claims.

The workpiece handling apparatus according to the invention is suitable for the handling of at least one panel-type workpiece which preferably consists at least in part of wood, wood-containing material, composite material or plastics material. The workpiece handling apparatus thereby comprises according to the invention a lifting unit and a gripping unit.

The gripping unit is adapted to perform a displacement movement parallel to at least a first direction R1 and additionally comprises a workpiece pick-up device which is so configured that it is able to enter into a reversible force-based and/or form-fitting connection with at least one panel-type workpiece. The workpiece pick-up device can be in the form of, for example, a vacuum gripper or a clamping gripper.

The gripping unit is further so configured that the workpiece pick-up device can perform a displacement movement parallel to a second direction R2 which is different from the first direction R1.

The lifting unit of the workpiece handling apparatus has at least one guide element. This is so configured that it can likewise perform a displacement movement parallel to the second direction R2. In addition, the guide element is configured to limit at least one degree of freedom of movement of one or more panel-type workpieces.

Compared to the prior art, a workpiece handling apparatus according to the invention has at least the advantage that panel-type workpieces for handling do not necessarily have to assume a specified position with respect to the direction R2. As a result, a workpiece handling apparatus according to the invention is significantly more flexible and more efficient than known workpiece handling apparatuses.

According to the invention, the at least one guide element can comprise a guide roller, an arrangement of multiple guide rollers, one or more guide rails or one or more conveyor belts. Moreover, a combination of the mentioned elements is also conceivable. The mentioned embodiments are advantageous inasmuch as the components required therefor are obtainable inexpensively and in standardised form.

The at least one guide element can be made of metal, plastics material or rubber or can be coated with plastics material or rubber. Preferably, owing to the advantageous sliding, friction and/or abrasion properties, one of the plastics types polypropylene, polyethylene, polyoxymethylene or polyurethane is used.

Furthermore, the at least one guide element can be of passive form, wherein it provides a guide contour, for example, or forms a suitable friction pairing with the at least one panel-type workpiece to be guided. The at least one guide element can, however, also be of active form and in this respect have an independent drive. The passive variant can be advantageous owing to its low complexity, whereas guide elements of active form make possible higher handling speeds, in particular in the case of large and/or heavy workpieces.

The displacement movements of the gripping unit, of the workpiece pick-up device and/or of the at least one guide element can take place, for example, using hydraulically, pneumatically and/or electrically operated actuators. The mentioned actuators are distinguished, in connection with a workpiece handling apparatus according to the invention, in particular by a comparatively small installation space.

By means of the above-described features, the workpiece handling apparatus is adapted to move panel-type workpieces in a first direction R1 and a second direction R2, wherein the direction R2 is oriented preferably parallel to the direction of gravity or has a component that is oriented parallel to the direction of gravity. This embodiment is advantageous in particular when the panel-type workpieces to be handled are stored horizontally since in this case lateral guiding is not necessarily required during the movement.

However, the direction R2 can also be oriented as desired. It is noted in this respect that, although the direction R2 preferably extends linearly, it can also be described by a trajectory that is defined, for example, by a three-dimensional vector field. A movement parallel to a direction R2 can thus also be referred to as a movement parallel to a trajectory R2 and can accordingly have not only translational but also rotational components.

Correspondingly, this is also the case for the direction R1. In other words, it is the case for the directions R1 and R2 that they can be described by two non-identical three-dimensional vector fields.

Displacement movements along non-linear trajectories can be necessary, for example, when horizontally stored workpieces are to be brought into a non-horizontal position for processing.

According to the invention, the gripping unit and the lifting unit of the workpiece handling apparatus can have a common control unit. This is preferably adapted to control the first displacement speed of the workpiece pick-up device v1 and the second displacement speed of the at least one guide element v2. According to the invention, the control unit is particularly preferably adapted to make possible an operating state in which the component oriented parallel to the second direction R2 with the first displacement speed v1 and the component oriented parallel to the second direction R2 with the second displacement speed v2 are identical. An advantage of such an operating state that may be mentioned is the uniform and secure movement of a panel-type workpiece to be handled during the displacement movement parallel to the direction R2.

According to the invention, the workpiece handling apparatus can be combined with a storage apparatus and forms a system together therewith. A storage apparatus belonging to this system is suitable for storing at least one panel-type workpiece. Where multiple panel-type workpieces are stored in or on the storage apparatus, they are preferably arranged in a stack. A fundamental characteristic of the system consists in that the gripping unit of the workpiece handling apparatus is so configured that the workpiece pick-up device is able to enter into a reversible, force-based and/or form-fitting connection with at least one panel-type workpiece which is stored in or on the storage apparatus.

Such a system accordingly combines the advantages of a workpiece handling apparatus according to the invention with the advantages of a storage apparatus. As advantages of a storage apparatus there may be mentioned, for example, the storage of panel-type workpieces close to a processing machine and the associated short transport paths and setup times.

Furthermore, the storage apparatus is preferably adapted to move the at least one panel-type workpiece stored therein or thereon parallel to the second direction R2. This is advantageous inasmuch as the number of panel-type workpieces which can be retrieved by the workpiece handling apparatus can be increased further compared to a system which is not adapted to carry out the mentioned movement. The storage apparatus can make possible the mentioned movement particularly simply and comparatively inexpensively when it is in the form of a scissor lift table.

A processing machine according to the invention comprises a workpiece handling apparatus or a system as described above, as well as a processing table and a processing unit. The processing table has a workpiece supporting plane, and the processing unit is adapted to perform a displacement movement parallel to the first direction R1. In addition, the processing unit is fixedly connected to the gripping unit of the workpiece handling apparatus, which results in the advantage that additional drive and/or guide means do not have to be provided for the gripping unit.

The processing machine can be in the form of a flat-table machine, wherein the expression “flat-table machine” in the present context describes the fact that the workpiece supporting plane of the processing table is oriented perpendicularly to the direction of gravity. Flat-table machines are advantageous, for example, inasmuch as panel-type workpieces which are in the processing region of a flat-table machine remain at rest without the use of clamping means.

Furthermore, the lifting unit of the workpiece handling apparatus is preferably so configured that it can be recessed completely in the processing table of the processing machine. In this manner, it is possible for a panel-type workpiece that is to be processed to be stably fastened to the processing table of the processing machine. In addition, possible collisions between clamping means and parts of the lifting unit are avoided by the recessing of the lifting unit.

In order that the installation area of the processing machine according to the invention is not larger compared to a comparable processing machine without a workpiece handling apparatus, the lifting unit, or at least the at least one guide element of the lifting unit, can be integrated into the processing table of the processing machine. In concrete terms, this means that a boundary contour K1, which is defined as the vertical projection of the at least one guide element into the workpiece supporting plane, is enclosed in part or completely by a boundary contour K2, wherein the boundary contour K2 is defined as the vertical projection of the processing table into the workpiece supporting plane.

According to the invention there is also provided a method for batch processing panel-type workpieces with a processing machine. The processing machine thereby comprises a system comprising a workpiece handling apparatus and a storage apparatus, a processing table having a workpiece supporting plane, and a processing unit which is adapted to perform a displacement movement parallel to the first direction R1.

In the course of this method, the following steps are carried out, but not necessarily in the stated order:
1. displacing the workpiece pick-up device until it is in a position in which it is able to enter into a reversible, force-based and/or form-fitting connection with at least one panel-type workpiece which is stored in or on the storage apparatus;
2. producing a force-based and/or form-fitting connection between the workpiece pick-up device and at least one panel-type workpiece;
3. displacing the at least one guide element until it is in a position in which it is tangential to the surface of the panel-type workpiece that is facing the processing table;
4. displacing the workpiece pick-up device and the at least one panel-type workpiece connected thereto by a force-based and/or form-fitting connection, wherein the displacement movement is oriented parallel to the first direction R1;
5. simultaneously displacing the workpiece pick-up device and the at least one guide element in the direction R2 until the at least one panel-type workpiece touches the workpiece supporting plane of the processing table;
6. releasing the force-based and/or form-fitting connection between the workpiece pick-up device and the at least one panel-type workpiece;
7. fastening the at least one panel-type workpiece to the processing table, preferably using vacuum clamping elements;
8. processing the at least one panel-type workpiece.

Preferably, the acute angle which the at least one panel-type workpiece encloses with the workpiece supporting plane during all the method steps is between 0 and 45°, particularly preferably between 0 and 15°. Such an orientation is considered to be advantageous inasmuch as a uniform, homogeneous movement is thereby made possible.

Furthermore, a method according to the invention can comprise the following step: displacing the next panel-type workpiece to be processed parallel to the direction R2, wherein the panel-type workpiece is stored in or on the storage apparatus during the displacement movement. This can be made possible, for example, if the storage apparatus is in the form of a scissor lift table and the direction R2 is oriented parallel to the direction of gravity. In this manner, the number of panel-type workpieces which can be retrieved by the workpiece handling apparatus is increased compared to a method without the additional step. The present invention can not only be used for transferring one or more panel-type workpieces from a storage apparatus to a processing table of a processing machine. A method according to the invention can further be provided which has the aim of transferring one or more processed workpieces from the processing table of a processing machine to a storage apparatus.

For this purpose, the processing machine can be so configured that the workpiece pick-up device is displaceable parallel to a third direction R3, wherein the third direction R3 is different from the first direction R1 and the second direction R2. Furthermore, the processing machine can be so configured that it comprises a second storage apparatus. In this respect, the above-described method for batch processing panel-type workpieces can be supplemented by the following steps:
1. producing a force-based and/or form-fitting connection between the workpiece pick-up device and at least one processed panel-type workpiece;
2. simultaneously displacing the workpiece pick-up device and the at least one guide element parallel to the second direction R2;
3. simultaneously displacing the workpiece pick-up device and the at least one processed panel-type workpiece connected thereto by a force-based and/or form-fitting connection parallel to the third direction R3, wherein the at least one processed panel-type workpiece is stored on or in the second storage apparatus when the displacement movement is complete.

A method of this type has the advantage that, in addition to efficient loading, efficient removal of panel-type workpieces is made possible.

### BRIEF DESCRIPTION OF THE DRAWINGS

Preferred embodiments of the present invention and further configurations and advantages will become apparent from the following description of the figures:

FIG. 1 shows a first embodiment of a workpiece handling apparatus according to the invention with a panel-type workpiece in a first state;

FIG. 2 shows a first embodiment of a workpiece handling apparatus according to the invention with a panel-type workpiece in a second state;

FIG. 3 shows a second embodiment of a workpiece handling apparatus according to the invention with a panel-type workpiece in a first state;

FIG. 4 shows a second embodiment of a workpiece handling apparatus according to the invention with a panel-type workpiece in a second state;

FIG. 5 shows a third embodiment of a workpiece handling apparatus according to the invention with a panel-type workpiece in a first state;

FIG. 6 shows a first embodiment of a system according to the invention consisting of a workpiece handling apparatus and a storage apparatus in a first state;

FIG. 7 shows a first embodiment of a system according to the invention consisting of a workpiece handling apparatus and a storage apparatus in a second state;

FIG. 8 shows a first embodiment of a system according to the invention consisting of a workpiece handling apparatus and a storage apparatus in a third state;

FIG. 9 shows a first embodiment of a processing machine according to the invention in a side view in a first state;

FIG. 10 shows a first embodiment of a processing machine according to the invention in a side view in a second state;

FIG. 11 shows a first embodiment of a processing machine according to the invention in a side view and in the absence of panel-type workpieces;

FIG. 12 shows a second embodiment of a processing machine according to the invention in an isometric view in a first state;

FIG. 13 shows a second embodiment of a processing machine according to the invention in an isometric view in a second state;

FIG. 14 shows a second embodiment of a processing machine according to the invention in a view perpendicular to the workpiece supporting plane.

### DETAILED DESCRIPTION OF PREFERRED EMBODIMENTS

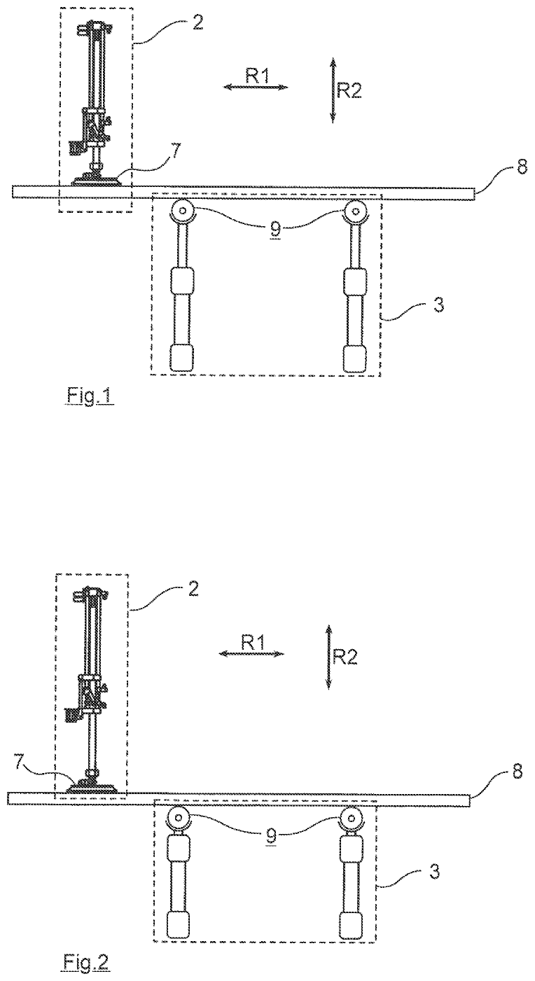

FIG. 1 shows a first preferred embodiment of the workpiece handling apparatus 1 according to the invention in a first state. The workpiece handling apparatus can be used for handling panel-type workpieces 8, for example solid wood or chipboard panels, and generally comprises a lifting unit 3 and a gripping unit 2. The gripping unit 2 is adapted to perform a displacement movement parallel to a first direction R1, wherein the direction R1 in the present case runs linearly and horizontally.

The gripping unit 2 comprises a workpiece pick-up device 7, which is in the form of a vacuum gripper. In the state shown, the vacuum gripper has been brought into a force-based connection with a panel-type workpiece 8. However, the vacuum gripper is so configured that the connection can also be released. The gripping unit 2 is further so configured that the vacuum gripper can be moved parallel to a second direction R2 using a pneumatically or optionally hydraulically operated working cylinder. In the embodiment shown, the direction R2 runs linearly and parallel to the direction of gravity. The lifting unit 3 of the workpiece handling apparatus 1 has two guide elements 9, which are in the form of rollers. The rollers are each mounted on hydraulically operated working cylinders, so that they can be moved parallel to the direction R2. Furthermore, the rollers are so arranged that they support the panel-type workpiece 8 so that it does not fall as a result of gravity.

FIG. 2 shows the same embodiment of a workpiece handling apparatus according to the invention as FIG. 1, but in a second state which is different from the first state. This second state is reached starting from the first state shown in FIG. 1 by the workpiece pick-up device 7 and the guide elements 9 being displaced together with a panel-type workpiece 8 parallel to the second direction R2.

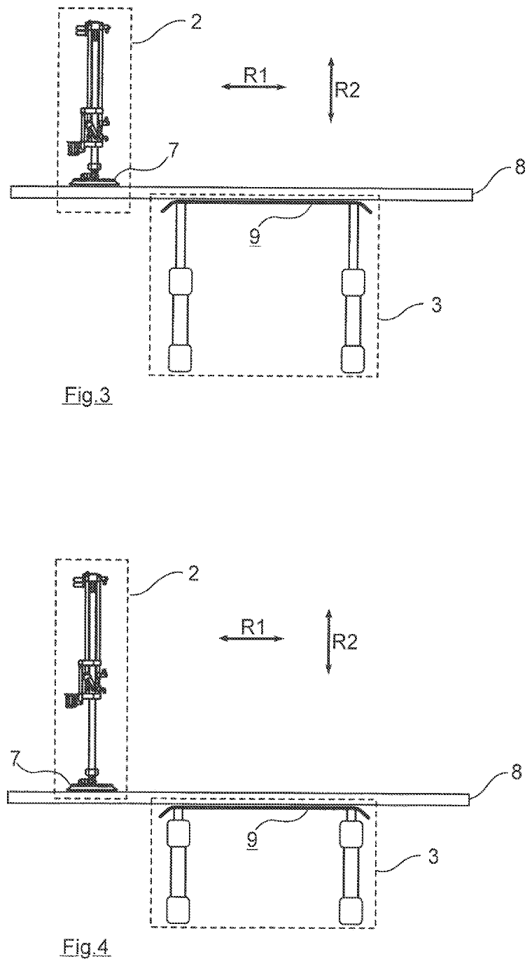

FIGS. 3 and 4 also show a preferred embodiment of a workpiece handling apparatus 1 according to the invention in two different states. The second embodiment shown in FIG. 3 and FIG. 4 differs from the first embodiment shown in FIG. 1 and FIG. 2 only in that, instead of two rollers, a guide rail is provided as the guide element 9. In the embodiment shown, the guide rail is made of metal and, in order to optimise the sliding properties, is coated with plastics material of the polyoxymethylene type. The states shown in FIG. 3 and FIG. 4 correspond to the states of FIG. 1 and FIG. 2, respectively.

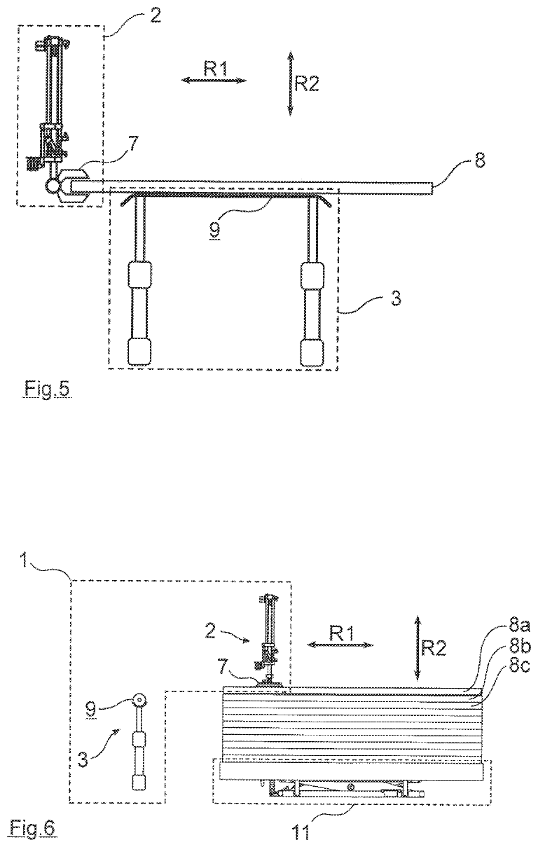

FIG. 5 shows a third preferred embodiment of a workpiece handling apparatus 1 according to the invention. The difference with respect to the second embodiment shown in FIG. 3 and FIG. 4 consists in that the workpiece pick-up device 7 is not in the form of a vacuum gripper but in the form of a clamping gripper. The state of the workpiece handling apparatus shown corresponds to the state shown in FIG. 1 and FIG. 3.

A workpiece handling apparatus 1 according to one of the above-described embodiments also comprises a control unit 10, although this is not depicted in FIGS. 1 to 5. This control unit 10 is adapted to control the first displacement speed of the workpiece pick-up device v1 and the second displacement speed of the guide elements v2 and to make possible an operating state in which the component oriented parallel to the second direction R2 with the first displacement speed v1 and the component oriented parallel to the second direction R2 with the second displacement speed v2 are identical.

FIGS. 6, 7 and 8 show a preferred embodiment of a system according to the invention, wherein a system according to the invention comprises a workpiece handling apparatus 1 and a storage apparatus 11. The storage apparatus 11 is thereby in the form of a scissor lift table and stores multiple panel-type workpieces 8a, 8b, 8c, . . . in the form of a panel stack. The workpiece handling apparatus 1 comprises a lifting unit 3 and a gripping unit 2. The gripping unit 2 is displaceable parallel to the direction R1 and has a workpiece pick-up device 7 which is displaceable parallel to the direction R2. This is in the form of a vacuum gripper comparably to the embodiment shown in FIGS. 1 to 4. The lifting unit comprises a guide element 9 which is in the form of a roller and is displaceable parallel to the direction R2.

FIG. 6 shows a state in which the gripping unit 2 has been brought into a position in which the workpiece pick-up device 7 is able to enter into a force-based connection with the uppermost panel-type workpiece 8a stored on the storage apparatus 11. Furthermore, the guide element 9 of the lifting unit is in a position tangential to the plane that contains the supporting surface of the uppermost panel-type workpiece 8a.

The state shown in FIG. 7 is reached starting from the state in FIG. 6 by moving the gripping unit 2 together with the uppermost panel-type workpiece 8a parallel to the first direction R1. In the present case, the first direction R1 runs horizontally.

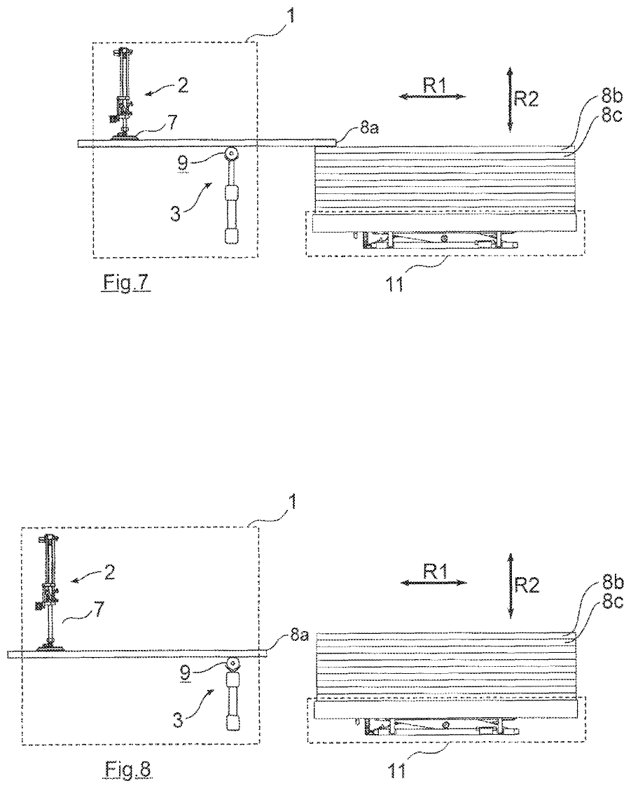

The state shown in FIG. 8 is reached starting from the state in FIG. 7 by further moving the panel-type workpiece 8a connected by a force-based connection to the workpiece pick-up device 7 parallel to the first direction R1 and additionally parallel to the second direction R2. While a movement only of the gripping unit 2 is necessary for a movement of the panel-type workpiece 8a parallel to the first direction R1, a movement of the panel-type workpiece 8a parallel to the second direction R2 additionally requires a movement of the guide element 9 of the lifting unit 3 and a movement of the workpiece pick-up device 7.

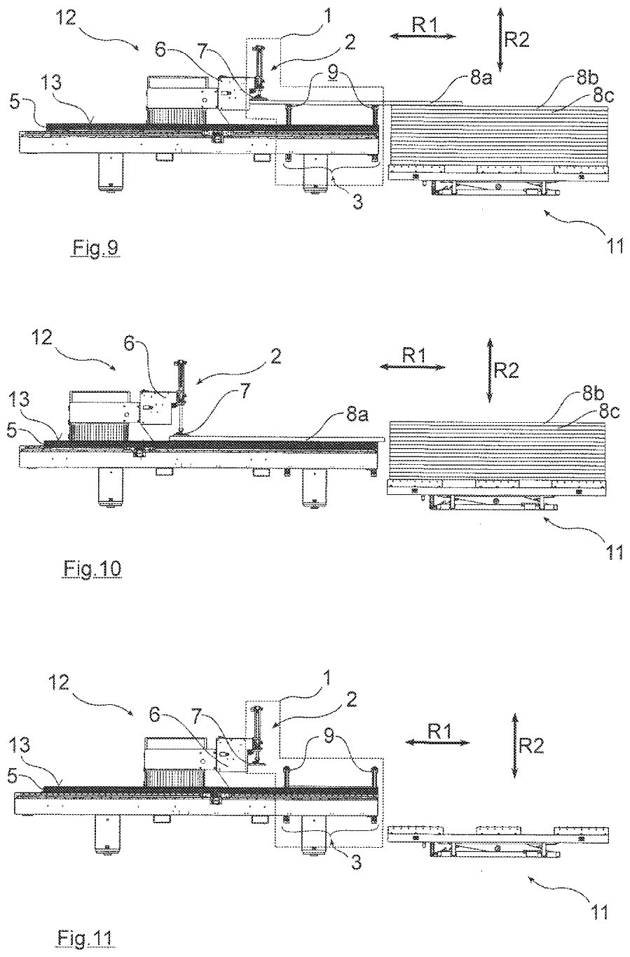

FIGS. 9 to 11 show a first preferred embodiment of a processing machine 12 according to the invention in a side view. The processing machine 12 is in the form of a CNC drilling machine and can be used, for example, for producing kitchen fronts. The processing machine 12 comprises a workpiece handling apparatus 1, consisting of a gripping unit 2 and a lifting unit 3 having guide elements 9 in the form of rollers, as well as a processing table 5 having a workpiece supporting plane 13, a processing unit 6 and a storage apparatus 11. The storage apparatus 11 is in the form of a scissor lift table, and the gripping unit 2 of the workpiece pick-up device 7 is, according to the invention, fixedly connected to the processing unit 6 of the processing machine 12.

FIG. 9 shows a first state, in which an uppermost panel-type workpiece 8a of a panel stack stored on the storage apparatus 11 has already been brought into a force-based and/or form-fitting connection with the workpiece pick-up device 7 of the gripping unit 2 and has been moved together with the gripping unit 2 parallel to the first direction R1. In this first state, the guide elements 9 of the lifting unit 3 are additionally in a position tangential to the surface of the panel-type workpiece 8a with which the panel-type workpiece 8a lies at least in part on the panel stack.

FIG. 10 shows a second state, in which the panel-type workpiece 8a, together with the gripping unit 2, has been moved further as compared to the state shown in FIG. 9 parallel to the first direction R1 and additionally parallel to the second direction R2. As a result of the movements, the panel-type workpiece 8a lies on the workpiece supporting plane 13 of the processing table 5, and the guide elements 9 of the lifting unit 3 are recessed in the processing table 5. In addition to the panel-type workpiece 8a, the processing unit 6 of the processing machine 12 and the gripping unit 2 fixedly connected to the processing unit 6 are also involved in the movement parallel to the first direction R1. In contrast, in addition to the panel-type workpiece 8a, the workpiece pick-up device 7 and the guide elements 9 of the lifting unit 3 are also involved in the movement parallel to the second direction R2.

FIG. 11 shows a processing machine 12 in the absence of panel-type workpieces. The state of the processing machine corresponds to FIG. 9.

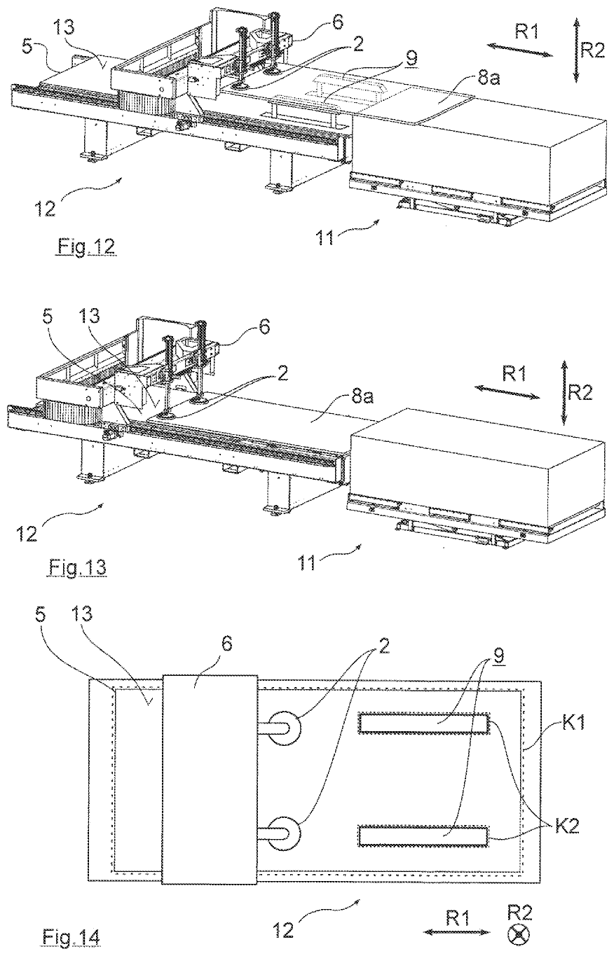

FIGS. 12 and 13 show a second preferred embodiment of a processing machine 12 according to the invention in an isometric view. The difference with respect to the first embodiment shown in FIGS. 9 to 11 consists in that the guide elements 9 are not in the form of rollers but in the form of rails. The state shown in FIG. 12 corresponds to FIG. 9, the state shown in FIG. 13 corresponds to FIG. 10.

FIG. 14 shows the second preferred embodiment of a processing machine 12 shown in FIG. 12 and FIG. 13 in a plan view. In addition to the gripping unit 2, which is fixedly connected to the processing unit 6, the first boundary contour K1 and the second boundary contour K2 are also visible. The first boundary contour K1 is given by the vertical projection of the processing table 5 into the workpiece supporting plane 13, the second boundary contour K2 is given by the vertical projection of the guide elements 9 into the workpiece supporting plane 13. In the embodiment shown, the second boundary contour K2 is enclosed completely by the first boundary contour K1.

### REFERENCE NUMERALS

1 Workpiece handling apparatus
2 Gripping unit
3 Lifting unit
4 Processing machine
5 Processing table
6 Processing unit
7 Workpiece pick-up device
8 Panel-type workpiece
8a One of multiple panel-type workpieces
8b,c . . . Further panel-type workpieces
80 Processed panel-type workpiece
9 Guide element
10 Control unit
11 Storage apparatus
11a Second storage apparatus
12 Processing machine
13 Workpiece supporting plane
v1 First displacement speed
v2 Second displacement speed
R1 First direction
R2 Second direction
R3 Third direction
K1 First boundary contour
K2 Second boundary contour

1. Workpiece handling apparatus (1) for handling at least one preferably panel-type workpiece (8) which preferably consists at least in part of wood, wood-containing material, composite material or plastics material, comprising
a lifting unit (3) and a gripping unit (2), wherein the gripping unit (2) is adapted to perform a displacement movement parallel to at least a first direction (R1), and the gripping unit (2) has a workpiece pick-up device (7) which is so configured that it is able to enter into a reversible, force-based and/or form-fitting connection with at least one panel-type workpiece (8),
characterised in that
the gripping unit (2) is so configured that the workpiece pick-up device (7) can perform a displacement movement parallel to a second direction (R2) which is different from the first direction (R1), and the lifting unit (3) has at least one guide element (9) which is configured to perform a displacement movement parallel to the second direction (R2), and which is additionally configured to limit at least one degree of freedom of movement of the at least one panel-type workpiece (8).

2. Workpiece handling apparatus (1) according to claim 1,
characterised in that
the second direction (R2) is oriented parallel to the direction of gravity or has a component that is oriented parallel to the direction of gravity.

3. Workpiece handling apparatus (1) according to any one of the preceding claims,
characterised in that
the at least one guide element comprises at least one guide roller, at least one guide rail and/or at least one conveyor belt.

4. Workpiece handling apparatus (1) according to any one of the preceding claims,
characterised in that
the workpiece pick-up device (7) is in the form of a vacuum gripper or clamping gripper.

5. Workpiece handling apparatus (1) according to any one of the preceding claims,
characterised in that
the gripping unit (2) and/or the lifting unit (3) has at least one hydraulically, pneumatically and/or electrically operated actuator.

6. Workpiece handling apparatus (1) according to any one of the preceding claims,
characterised in that
the gripping unit (2) and the lifting unit (3) have a common control unit (10) which is preferably adapted to control the first displacement speed of the workpiece pick-up device (v1) and the second displacement speed of the at least one guide element (v2), and which is particularly preferably adapted to make possible an operating state in which the component oriented parallel to the second direction (R2) with the first displacement speed (v1) and the component oriented parallel to the second direction (R2) with the second displacement speed (v2) are identical.

7. System, comprising a workpiece handling apparatus (1) according to any one of the preceding claims and a storage apparatus (11) for storing at least one panel-type workpiece (8), wherein in the case of multiple panel-type workpieces (8a, 8b, . . . ) they are arranged on the storage apparatus (11) preferably in a stack,
characterised in that
the gripping unit (2) is so configured that the workpiece pick-up device (7) is able to enter into a reversible, force-based and/or form-fitting connection with at least one panel-type workpiece (8) which is stored in or on the storage apparatus (11).

8. System according to claim 7,
characterised in that
the storage apparatus (11) is so configured that the at least one panel-type workpiece (8) can be moved parallel to the second direction (R2).

9. Processing machine (12), preferably in the form of a flat-table machine, comprising either a workpiece handling apparatus (1) according to any one of claims 1 to 6 or a system according to either claim 7 or claim 8, as well as a processing table (5) which has a workpiece supporting plane (13), and a processing unit (6) which is adapted to perform a displacement movement parallel to the first direction (R1),
characterised in that
the gripping unit (2) is fixedly connected to the processing unit (6).

10. Processing machine (12) according to claim 9,
characterised in that
the lifting unit (3) can be recessed completely in the processing table (5) of the processing machine (12).

11. Processing machine (12) according to either claim 9 or claim 10, wherein the processing table (5) has a first boundary contour (K1) and the at least one guide element (9) has a second boundary contour (K2), wherein the first boundary contour (K1) is defined as the vertical projection of the processing table (5) into the workpiece supporting plane (13), and the second boundary contour (K2) is defined as the vertical projection of the at least one guide element (9) into the workpiece supporting plane (13),
characterised in that
the first boundary contour (K1) and the second boundary contour (K2) overlap, or the second boundary contour (K2) is enclosed completely by the first boundary contour (K1).

12. Method for batch processing panel-type workpieces (8) with a processing machine (12) comprising a system according to either claim 6 or claim 7 as well as a processing table (5) which has a workpiece supporting plane (13), and a processing unit (6) which is adapted to perform a displacement movement parallel to the first direction (R1), comprising the steps:
1) displacing the workpiece pick-up device (7) until it is in a position in which it is able to enter into a reversible, force-based and/or form-fitting connection with at least one panel-type workpiece (8) which is stored in or on the storage apparatus (11);
2) producing a force-based and/or form-fitting connection between the workpiece pick-up device (7) and at least one panel-type workpiece (8);
3) displacing the at least one guide element (9) until it is in a position in which it is tangential to the surface of the panel-type workpiece (8) that is facing the processing table (5);
4) displacing the workpiece pick-up device (7) and the at least one panel-type workpiece (8) connected thereto by a force-based and/or form-fitting connection, wherein the displacement movement is oriented parallel to the first direction (R1);
5) simultaneously displacing the workpiece pick-up device (7) and the at least one guide element (9) parallel to the second direction (R2) until the at least one panel-type workpiece (8) touches the workpiece supporting plane (13) of the processing table (5);
6) releasing the force-based and/or form-fitting connection between the workpiece pick-up device (7) and the at least one panel-type workpiece (8);
7) fastening the at least one panel-type workpiece (8) to the processing table (5), preferably using vacuum clamping elements;
8) processing the at least one panel-type workpiece (8);
wherein
the order of the steps can be varied, and wherein the acute angle which the at least one panel-type workpiece (8) encloses with the workpiece supporting plane (13) during steps 1) to 8) preferably assumes a value between 0 and 45° and particularly preferably a value between 0 and 15°.

13. Method according to claim 12,
further comprising the step:
displacing the next panel-type workpiece (8) to be processed, parallel to the second direction (R2), while it is stored in or on the storage apparatus (11).

14. Method according to either claim 12 or claim 13, wherein the processing machine (12) is so configured that the workpiece pick-up device (7) is displaceable parallel to a third direction R3, wherein the third direction R3 is different from the first direction (R1) and the second direction (R2), and wherein the processing machine (12) comprises a second storage apparatus (11a),
further comprising the steps:
1) producing a force-based and/or form-fitting connection between the workpiece pick-up device (7) and at least one processed panel-type workpiece (80);
2) simultaneously displacing the workpiece pick-up device (7) and the at least one guide element (9) parallel to the second direction (R2);
3) simultaneously displacing the workpiece pick-up device (7) and the at least one processed panel-type workpiece (80) connected thereto by a force-based and/or form-fitting connection parallel to the third direction R3, wherein the at least one processed panel-type workpiece (80) is stored on or in the second storage apparatus (11a) when the displacement movement is complete.
